(19) United States
(12) Patent Application Publication
(10) Pub. No.: US 2015/0321282 A1
(43) Pub. Date: Nov. 12, 2015

(54) HIGH CAPACITY ALUMINUM SPOT WELD ELECTRODE

(71) Applicant: FORD GLOBAL TECHNOLOGIES, LLC, Dearborn, MI (US)

(72) Inventors: William C. Moision, Northville, MI (US); Elizabeth Therese Hetrick, Ann Arbor, MI (US)

(73) Assignee: FORD GLOBAL TECHNOLOGIES, LLC, Dearborn, MI (US)

(21) Appl. No.: 14/271,518

(22) Filed: May 7, 2014

(51) Int. Cl. B23K 11/30; B23K 11/18

(52) U.S. Cl. CPC B23K 11/3018; B23K 11/185

(57) ABSTRACT

A welding electrode assembly is provided including a mounting adapter, a shank and an electrode cap. The electrode assembly includes a shortened shank reinforced over a larger percentage of its length by the mounting adapter and electrode cap. Further, the cap includes a larger or longer working end allowing for the completion for more spot weld operations before requiring replacement.

### TECHNICAL FIELD

This document relates generally to the resistance spot welding field and, more particularly to an improved electrode for the resistance spot welding of aluminum at high clamping pressures and high welding currents.

### BACKGROUND

The use of aluminum in the construction of automobiles, trucks and other vehicles is steadily increasing. This is because it offers a number of advantages to iron alloys including the fact that it is lower density and corrosion resistant. The use of aluminum allows vehicle manufacturers to maintain safety and strength requirements while the resulting reduction in weight advantageously reduces engine-load which decreases the consumption of fuel and exhaust emissions.

Resistance spot welding is a technique utilized by vehicle manufacturers to join aluminum workpieces. Advantageously, resistance spot welding is relatively low cost, rapid, simple and easy to automate. Recent developments and advancements in mid-frequency power sources, electrode dressing and servo gun equipment further support the increased use of resistance spot welding of aluminum in vehicle manufacturing.

Significantly, high power welding guns are required as aluminum welding currents must be two to three times higher than required for steel yet aluminum welding times are perhaps ¼ to ½ that required for steel. Thus, aluminum welding equipment must be able to deliver high current levels in a time window that is 50-75% shorter than what is commonly employed for steel. These requirements clearly highlight the need to have proper weld pressure and electrode alignment when initiating the welding operation.

Toward this end, U.S. Patent Application Publication No. 2013/0020288 to Moision et al. discloses a system and method for welding aluminum workpieces wherein a predetermined current is applied through electrodes that engage the workpieces. A resistance profile is then generated based upon the predetermined current. A proper weld profile is then selected based upon the resistance profile. The weld profile is then used to execute the workpiece weld.

Welding currents and current profiles are not the only parameters that may be utilized to efficiently provide consistently high quality aluminum welds. In fact changes in the clamping force applied to the workpieces have an effect on (a) the pressure between the welding electrode and the workpieces and (b) the resistance distribution at the electrode-workpiece interfaces. It has recently been determined that spot welding forces of up to 12 kN and welding currents of up to 80 kA may be useful in providing the most effective and high quality welds between aluminum workpieces such as bodies made from aluminum alloy sheet material.

A prior art aluminum spot welding electrode assembly E of three piece construction is illustrated in FIG. 3. The electrode assembly E comprises a mounting adapter A, a shank S and an electrode cap C. The mounting adapter A includes a mounting end T to allow the electrode assembly E to be secured to a welding gun. An integrated hex nut N allows for tightening and loosening of the connection.

The mounting adapter A also includes a bore that receives and holds a tapered portion P of the shank S. The sidewall R of the adapter A engages and reinforces this portion P of the shank S. A socket K at the distal end of the shank S receives the mounting end M of the electrode cap C. The working end or welding portion D of the cap C extends from the shank S.

The welding electrode assembly E is made from copper or copper alloy. The shank S includes a lumen U for the circulation of water or other cooling medium to the cooling passage G in the electrode cap C to reduce electrode heating during the welding process. This lumen U compromises the structural integrity of the shank S to the extent that it is not capable of withstanding spot welding forces up to 12 kN and welding currents of up to 80 kA over an appropriate service life.

This document relates to a novel welding electrode assembly characterized by improved strength and extended service life when subjected to spot welding forces up to 12 kN and welding currents of up to 80 kA. Advantageously the new electrode provides these benefits yet is still made from the same material and is the same overall standard length of the prior art electrode assembly E. Thus, the new electrode may be used with standard welding guns, standard electrode dressing equipment and standard electrode changing equipment already installed and in operation on the production line.

### SUMMARY

In accordance with the purposes and benefits described herein a new welding electrode assembly is provided. That welding electrode assembly comprises a body and an electrode cap carried on the body. The electrode cap has a mounting end connected to the body and a working end for welding. Further the electrode cap includes a raised rim between the mounting and working ends to protect the body during electrode cap dressing and facilitate electrode cap removal when changing the electrode cap.

The electrode cap further includes a liquid cooling passage. The liquid cooling passage extends through the mounting end and past the rim. In one embodiment the ratio of length of the mounting end to length of the working end is between 1 to 0.6 and 1 to 1.9. In another embodiment the ratio of length of the mounting end to length of the working end is between 1 to 1.5 and 1 to 1.7. In still another embodiment, the ratio of length of the mounting end to length of the working end is about 1 to 1.3.

Still further, in one embodiment the ratio of the length of the liquid cooling passage to length of the electrode cap is between 1 to 1.3 and 1 to 2.0. In yet another embodiment the ratio of the length of the liquid cooling passage to the length of the electrode cap is between 1 to 1.65 and 1 to 1.75.

In one embodiment, the mounting end has a taper angle of about 1°26′+/−0°3′ and a wall thickness of between about 1.98 and 2.71 mm. The liquid cooling passage has a diameter of about 12.7+/−0.3 mm. Taken together the increased wall thickness and larger cross-sectional area of the cooling passage greatly enhance the performance of the electrode cap.

Still further, the working end has a length of 20.5+/−0.3 mm and a diameter of 19.1+/−0.3 mm. The added length of the working end substantially increases the service life of the electrode cap.

In accordance with an additional aspect, in a three-piece welding electrode assembly having an overall length L, the shank has an overall length of between 0.41 and 0.59 L with between 0.29 and 0.60 L of that length being received in the tapered bore or socket and reinforced by the sidewall of the mounting adapter. Further between 0.16 and 0.33 L of the shank length receives the mounting end of the electrode cap and is thereby reinforced by the electrode cap. Accordingly, between 45.3 and 92.9% of the overall length of the shank is structurally reinforced by the mounting end of the electrode cap and the sidewall of the mounting adapter.

In an alternative embodiment the shank is an overall length of between 0.52 and 0.59 L with between 0.29 and 0.40 L of the proximal end of the shank length being received in the socket or tapered bore and reinforced by the mounting adapter. Further between 0.16 and 0.22 L of the shank length receives the mounting end of the electrode cap and is thereby reinforced by the electrode cap. Thus, between 45.3% and 61.1% of the overall length of the shank is structurally reinforced by the mounting end of the end cap and the sidewall of the mounting adapter.

These and other embodiments of the welding electrode assembly will be set forth in part in the description which follows, and in part will become apparent to those of ordinary skill in the art by reference to the following description and drawing figures.

### BRIEF DESCRIPTION OF THE DRAWINGS

The accompanying drawings incorporated herein and forming a part of the specification, illustrate several aspects of the welding electrode assembly and together with the description serve to explain certain principles thereof. In the drawings:

FIG. 1 is an exploded perspective view of the welding electrode assembly that is the subject of this document.

FIG. 2 is a cross-sectional view of the assembled welding electrode assembly illustrated in FIG. 1.

FIG. 2A is a side elevational view of the welding assembly presented to more clearly illustrate the internal passages within the various components of the assembly.

FIG. 3 is a cross-sectional view of a prior art welding electrode assembly that may be replaced by the welding electrode assembly illustrated in FIG. 2. FIGS. 2 and 3 are presented for purpose of comparison.

Reference will now be made in detail to the present preferred embodiments of the welding electrode assembly.

### DETAILED DESCRIPTION

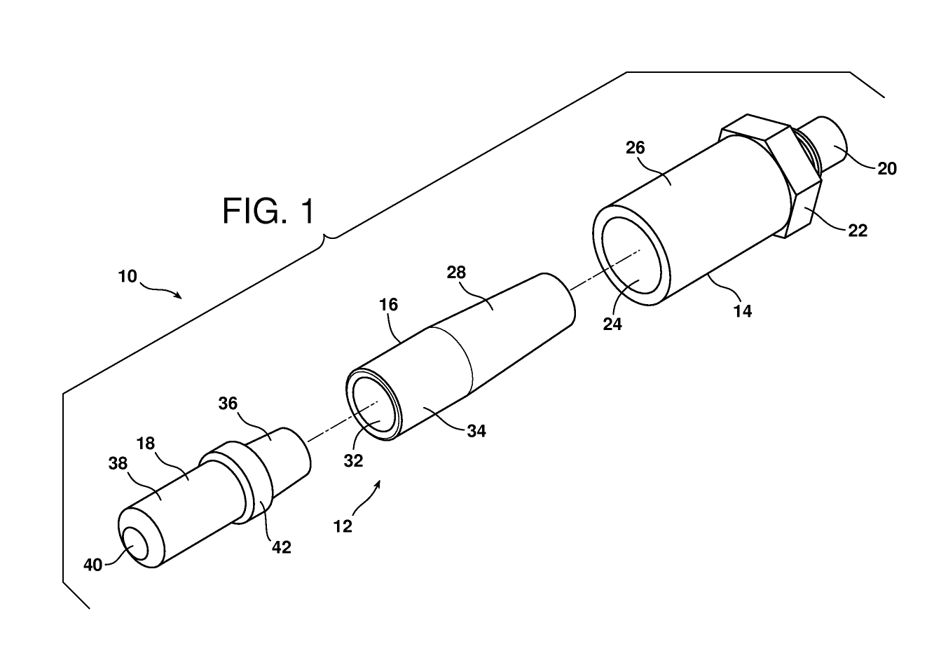

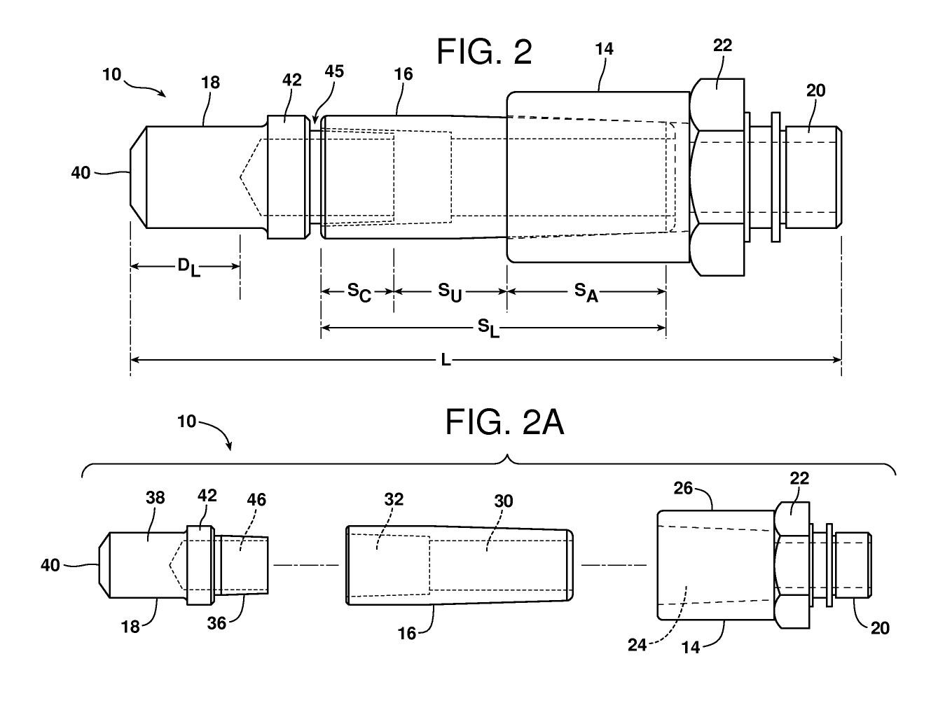

Reference is now made to FIGS. 1, 2 and 2A illustrating the welding electrode assembly 10. The welding electrode assembly 10 includes a body 12 comprising a mounting adapter 14 and a shank 16. An electrode cap 18 is secured to the shank 16 and provides the complete three piece welding electrode assembly 10. The entire welding electrode assembly 10 may be made from a material having high thermal and electrical conductivity as well as high hardness. Appropriate materials include copper and its alloys known to be useful in the construction of aluminum welding electrodes. For example, copper may be made harder by alloying it with zirconium, cobalt, chromium and even aluminum oxide.

As illustrated, the mounting adapter 14 includes a mounting end 20 for engaging a cooperating electrode receiving aperture in a welding gun. The integral hex nut 22 allows one to securely tighten the welding electrode assembly 10 to the welding gun or loosen the same when necessary for maintenance or changing of the welding electrode assembly. The mounting adapter 14 further includes a tapered bore or socket 24 having a sidewall 26 made of relatively heavy gauge material.

The shank 16 includes a proximal or tapered mounting end 28 and a distal end 34. As illustrated in FIG. 2, when properly assembled, the mounting end 28 of the shank 16 is fully received and held within the tapered bore 24 of the mounting adapter 14. The taper of the mounting end 28 matches the taper of the bore 24 so that the sidewall 26 engages and reinforces the shank 16. This provides added strength to the mounting end 28 of the shank 16. When secured together, a central liquid cooling lumen or bore 30, running through the shank 16, communicates with the tapered bore 24 in the mounting adapter 14. A tapered counterbore 32 in the end of the distal end 34 of the shank 16 is provided to receive the electrode cap 18 in a manner that will be described in greater detail below.

As illustrated, the electrode cap 18 includes a tapered mounting end 36, that is received and engages the counterbore 32 in the shank 16, and a working end 38 having a face 40 for engaging the aluminum workpiece to be welded. More specifically, the mounting end 36 has a taper angle of about 1°26′+/−0°3′ and a wall thickness of between about 2.16 and 2.56 mm. A raised rim 42 extends concentrically around the electrode cap 18 on the working end 38. In one possible embodiment, that rim 42 is raised between 1.2 mm and 2.4 mm above the outer surface of the end 38 and may be between 21.9 and 22.5 mm wide (diameter). Further, the raised rim 42 may include edging or roughened surface features if desired to aid in gripping or holding the electrode cap 18 when it is inserted into or removed from the shank 16 during electrode cap changing operations.

As further illustrated in FIGS. 2 and 2A, the electrode cap 18 also includes a liquid cooling passage 46. The cooling passage 46 has a diameter of about 12.7+/−0.3 mm. Significantly, the liquid cooling passage 46 extends through the entire length of the mounting end 36 and in the illustrated embodiment, just past the raised rim 42. When the welding electrode assembly 10 is properly assembled, the liquid cooling passage 46 is in direct fluid communication with the central cooling lumen 30 in the shank 16 which is in direct communication with the tapered bore 24. Cooling liquid such as water or other cooling medium is directed from the welding gun (not shown) through the tapered bore 24, the cooling lumen 30 and into the cooling passage 46 of the welding electrode assembly 10. In this way it is possible to maintain a lower operating temperature for the welding electrode assembly 10 during the welding operation thereby increasing the service life of the assembly and also reducing the buildup of workpiece material on the operating face 40 of the electrode cap 18.

In one possible embodiment, the ratio of the length of the mounting end 36 to the length of the working end 38 is between 1 to 0.6 and 1 to 1.9. In another possible embodiment, that ratio is between 1 to 1.5 and 1 to 1.7. In yet another, that ratio is about 1 to 1.3. In one possible embodiment the working end has a length of 20.5+/−0.3 mm and a diameter of 19.1+/−0.3 mm. Thus the length is greater than the diameter.

In one possible embodiment, the ratio of the length of the liquid cooling passage 46 to the overall length of the electrode cap 18 is between 1 to 1.3 and 1 to 2.0. In yet another embodiment, that ratio is between 1 to 1.65 and 1 to 1.75. When these ratios of the length of the mounting end 36 to the length of the working end 38 and the length of the liquid cooling passage 46 to the overall length of the electrode cap 18 are considered together, it is possible to provide an electrode cap with a longer working end while still providing the desired cooling to support an extended service life.

As indicated previously, the raised rim 42 on the electrode cap 18 may be conveniently utilized when handling the cap during insertion into and removal from the shank 16. The raised rim 42 feature also serves to limit taper engagement and provides an indication of taper wear by viewing the width of the gap 45 between the rim 42 and the end of the shank 16 (see FIG. 2). It should also be appreciated that electrode caps 18 are typically dressed to restore the electrode face 40 to a desired geometry so as to produce consistent and high quality welds. Ideally the dressing operation is performed before the electrode wear contributes to poor weld quality. Dressing equipment may be implemented robotically and typically dressing only takes a few seconds. Accordingly, it may be completed during part transfer operations along the assembly line. Advantageously, the raised rim 42 helps protect the shank 16 from material spatter during welding and contact and material chips during the dressing operation.

It should be appreciated that the raised rim 42 is just one of the unique aspects of the welding electrode assembly 10. The following Table 1 compares other significant physical attributes of the new electrode assembly 10 to the prior art electrode assembly E. As should be appreciated, while the taper angle is the same, the wall thickness at the taper of the electrode assembly 10 is about 59-81% thicker than for the electrode assembly E (2.71 vs. 1.70 and 1.98 vs. 1.09). The heavier gauge and larger diameter taper wall positively impacts load bearing capability, current carrying capability, overheating, electrode cap seating and removal. Further, these benefits are all achieved while minimizing taper depth/length of engagement so as to not comprise the access of the electrode assembly 10 to tight work spaces.

At the same time, the cooling passage diameter has been increased from 11.2 mm in the electrode assembly E to 12.7 mm in the electrode assembly 10. This represents about a 13% increase which improves and optimizes heat removal. Generally increases in cooling passage diameter are made at the expense of wall thickness. Significantly, both are increased in the electrode assembly 10 as compared to the prior art electrode assembly E.

As should be further appreciated, the length of the working end 38 of the electrode cap 18 has been increased dramatically by about 111% as compared to the working end of the electrode cap C (20.5 vs. 9.7), although increases of approximately 200% are possible. This potentially more than doubles the service life of the electrode cap 18 between changes thereby significantly improving line productivity. At the same time, the diameter of the working end 38 of the electrode cap 18 has been made consistent with the diameter of the working end of the prior art electrode cap C to allow standard use of electrode dressing and changing tools and weld set up tools (e.g. force gauges).

TABLE 1

| | PRIOR | |
|---|---|---|
| | ART ELECTRODE | NEW ELECTRODE |
| | ASSEMBLY E | ASSEMBLY 10 |
| Taper Angle | 1°26′ +/− 0°3′ | 1°26′ +/− 0°3′ |
| Wall Thickness | 1.09 mm-1.70 mm | 1.98 mm-2.71 mm |
| Cooling Passage | 11.2 +/− 0.3 mm | 12.7 +/− 0.3 mm |
| Diameter | | |
| Length of Working End/ | 9.7 +/− 0.3 mm | 9.7-29.0 +/− 0.3 mm |
| Material | | |
| Available for Dressing | | |
| Diameter of Working | 19.1 +/− 0.3 mm | 19.1 +/− 0.3 mm |
| End | | |

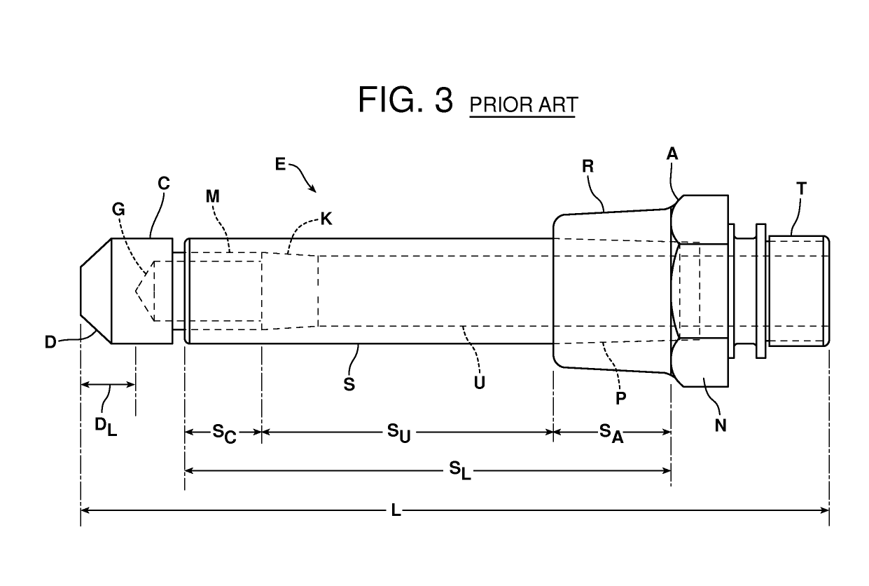

Significantly, the welding electrode assembly 10 provides a stronger and more durable construction and a larger or greater electrode cap dressing zone or working end 38 for a longer service life between cap changes than prior art electrode assemblies E of the same length L as illustrated in FIG. 3. These combined benefits are difficult to achieve while maintaining the standard length L and other characteristics that will allow the electrode assembly 10 to be substituted for the prior art electrode assembly E in standard welding guns, electrode dressing equipment and electrode changing equipment already found and operating on the manufacturing line. By carefully comparing FIGS. 2 and 3 it will be appreciated that in this example this is accomplished by reducing the overall length of the shank 16, as compared to the shank S, while increasing the area of engagement of the shank 16 in the mounting adapter 14 so as to reinforce the shank and improve the strength of the construction (note engagement of first portion 28 of shank 16 in the tapered bore 24 of the mounting adapter 14 as compared to the portion of the shank S received in the bore P of the shorter mounting adapter A). As should be further appreciated the thickness or gauge of the wall 26 of the mounting adapter 14 forming the tapered bore 24 is also increased as compared to the wall R of the mounting adapter A in the prior art electrode assembly E to provide still further reinforcement and strength. Further, the length of the working end 38 of the electrode cap 18 is significantly lengthened when compared to the working end D of the prior art cap C, so that there is more material to dress and thereby extend the service life of the welding electrode assembly 10 between cap changes.

As should be appreciated from reviewing FIG. 2, in one possible embodiment of the welding electrode assembly 10 having an overall length L, the shank 16 has an overall length of between 0.41 and 0.59 L with between 0.29 and 0.60 L of the mounting end 28 of the shank being received in the tapered bore 24 and reinforced by the sidewall 26 of the mounting adapter 14. Further, between 0.16 and 0.33 L of the length of the shank 16 receives the mounting end 36 of the electrode cap 18 and is thereby effectively reinforced by the cap. Thus, between 45.3% and 92.9% of the overall length of the shank 16 is structurally reinforced by either the mounting end 36 of the electrode cap 18 or the sidewall 26 of the mounting adapter 14.

In another possible embodiment, the shank 16 has an overall length of between 0.52 and 0.59 L with between 0.29 and 0.40 L of the proximal end 28 of the shank length being received in the bore 24 and reinforced by the sidewall 26 of the mounting adapter 14. Further between 0.16 and 0.22 L of the length of the shank 16 receives the mounting end 36 of the electrode cap and is thereby reinforced by the electrode cap. In this embodiment, between 45.3% and 61.1% of the overall length of the shank 16 is structurally reinforced.

For purposes of comparison to the prior art, reference is now made to FIGS. 2 and 3 which illustrate the overall length L of the welding electrode 10 of the present invention and the welding electrode assembly E of the prior art. As illustrated in these Figures, the shank 16/S makes up a length S_{L} of the overall length L of the electrode assembly 10/E with the S_{A} portion of that length being reinforced by the mounting adapter 14/A and the S_{C} portion of the length being reinforced by the mounting end 36/M of the electrode cap 18/C. S_{U} represents the length of the shank 16/S that remains unreinforced by either the mounting adapter 14/A or the electrode cap 18/C. As clearly illustrated, the unreinforced portion of the shank 16 in the welding electrode assembly 10 is substantially less than the overall length whereas the unreinforced portion S_{U} of the prior art electrode assembly E is substantially more than 50%. Significantly, the greater reinforcement of the shank S functions to increase the strength of the electrode assembly 10 versus the prior art electrode assembly E thereby allowing the electrode assembly 10 to be used over an extended service life even at spot welding forces up to 12 kN and welding currents of up to 80 kA. Further, as illustrated in FIGS. 2 and 3, the use of a shorter overall shank 16 in the welding electrode assembly 10 as compared to the shank S in the prior art electrode assembly E has allowed the use of an electrode cap 18 having a much longer dressing portion length D_{L} as compared to the dressing portion D_{L} of the prior art electrode assembly E, thereby providing a much longer service life between cap changes.

The foregoing has been presented for purposes of illustration and description. It is not intended to be exhaustive or to limit the embodiments to the precise form disclosed. Obvious modifications and variations are possible in light of the above teachings. For example, the connections between the electrode cap 18 and shank 16 and the shank 16 and the mounting adapter may be threaded. Further, while illustrated in conjunction with a three-piece electrode assembly 10, it should be appreciated that the electrode cap 18 may be used with an electrode of substantially any appropriate construction. All such modifications and variations are within the scope of the appended claims when interpreted in accordance with the breadth to which they are fairly, legally and equitably entitled.

What is claimed:

1. A welding electrode assembly, comprising:
a body;
an electrode cap carried on said body, said electrode cap having a mounting end connected to said body, a working end for welding and a raised rim between said mounting and working ends to protect said body during electrode cap welding and dressing, facilitate electrode cap removal when changing said electrode cap, and limit and control electrode cap engagement.

2. The assembly of claim 1 wherein said electrode cap further includes a liquid cooling passage.

3. The assembly of claim 2 wherein said liquid cooling passage extends through said mounting end and said rim.

4. The assembly of claim 3, wherein a ratio of length of said mounting end to length of said working end is between 1 to 0.6 and 1 to 1.9.

5. The assembly of claim 3, wherein a ratio of length of said mounting end to length of said working end is between 1 to 1.5 and 1 to 1.7.

6. The assembly of claim 3, wherein a ratio of length of said mounting end to length of said working end is about 1 to 1.3.

7. The assembly of claim 5, wherein a ratio of length of said liquid cooling passage to length of said electrode cap is between 1 to 1.3 and 1 to 2.0.

8. The assembly of claim 5, wherein a ratio of length of said liquid cooling passage to length of said electrode cap is between 1 to 1.65 and 1 to 1.75.

9. The assembly of claim 2 wherein said mounting end has a taper angle of about 1°26′+/−0°3′ and a wall thickness of between about 1.98 and 2.71 mm.

10. The assembly of claim 9, wherein said liquid cooling passage has a diameter of about 12.7+/−0.3 mm.

11. The assembly of claim 1, wherein said working end has a length of 20.5+/−0.3 mm and a diameter of 19.1+/−0.3 mm.

12. The assembly of claim 1, wherein said working end has a length and a diameter wherein said length is greater than said diameter.

13. In a three-piece welding electrode assembly of overall length L and including (a) a mounting adapter, (b) a shank having a proximal end received in a bore of the mounting adapter and (c) an electrode cap including a working end and a mounting end received in a counterbore in the shank, the improvement comprising:
said shank having an overall length of between 0.41 to 0.59 L with between 0.29 and 0.60 L of said proximal end of said shank being received in said bore and reinforced by said mounting adapter and between 0.16 and 0.33 L of said shank receiving said mounting end of said electrode cap and thereby being reinforced by said electrode cap.

14. The assembly of claim 13, wherein between 45.3% and 92.9% of said overall length of said shank is structurally reinforced by said mounting end of said electrode cap or a sidewall of said mounting adapter.

15. The assembly of claim 13, wherein between 45.3% and 61.1% of said overall length of said shank is structurally reinforced by said mounting end of said electrode cap or a sidewall of said mounting adapter.

16. The assembly of claim 14, wherein said electrode cap further includes a liquid cooling passage.

17. The assembly of claim 16, wherein said mounting end has a taper angle of about 1°26′+/−0°3′ and a wall thickness of between about 1.98 and 2.71 mm.

18. The assembly of claim 17, wherein said liquid cooling passage has a diameter of about 12.7+/−0.3 mm.

19. The assembly of claim 13, wherein said working end has a length of 20.5+/−0.3 mm and a diameter of 19.1+/−0.3 mm.

20. The assembly of claim 13, wherein said working end has a length and a diameter wherein said length is greater than said diameter.
